(19) United States
(12) Patent Application Publication
(10) Pub. No.: US 2007/0223593 A1
(43) Pub. Date: Sep. 27, 2007

(54) Determination of data groups suitable for parallel processing

(75) Inventor: Richard Wilding, Twickenham (GB)

Correspondence Address: GROOVER & HOLMES, BOX 802889, DALLAS, TX, 75380-2889, US

(73) Assignee: Creative Labs, Inc.

(21) Appl. No.: 11/386,467

(22) Filed: Mar. 22, 2006

(51) Int. Cl. H04N 7/12

(52) U.S. Cl. 375/240.26

(57) ABSTRACT

A system and method for identifying groups of data suitable for parallel processing. In one example embodiment, an algorithm traces boundaries around nodes in a two-dimensional data set by following dependencies between nodes. Groups within different boundaries are independent of one another and can be processed concurrently.

### BACKGROUND AND SUMMARY OF THE INVENTION

The present application relates to processing of two-dimensional (2D) data sets, and more particularly to determination of independent groups in order-dependent data groups.

### DESCRIPTION OF BACKGROUND ART

In data processing systems, there are often situations where data are processed (for example, coded or decoded) in dependence on the processing of other data. For example, in the video context, a video frame can be comprised of a two-dimensional set of macro blocks. Each macro block relates to a pixel region of a frame. For example, in the H.264 standard, each macro block relates to a 16×16 pixel region in the luma channel of a frame, and to an 8×8 pixel region in each of the chroma channels of the frame. Such macro blocks are typically either inter- or intra-coded. Macro blocks in a frame are often grouped into one or more slices. If a frame contains more than one slice, then the (intra-coded) macro blocks in a given slice can be decoded without reference to any macro block in a different slice. The intra-coded macro blocks within a slice may be dependent on other macro blocks in that same slice.

Coding or decoding is typically a hybrid of inter-picture prediction, transform coding, and motion compensation. Macro blocks within a slice are usually decoded in scanline order—left to right, top to bottom. A particular macro block can be dependent on other macro blocks nearby, usually those which occur earlier in scan-line order and which are adjacent to that block on a two-dimensional data set. For example, a given macro block could be dependent on up to three macro blocks which, due to the decode order, could be to the left of that block in the same scanline or in the scanline above the macro block. The exact dependencies of a particular macro block are governed by the encoder and will vary from one encoder to another, and even for a single encoder with different parameters. Therefore, a generic dependency between macro blocks in all contexts cannot be characterized. The only safe order to process intra-coded macro blocks using the information in the bit stream is the decode order, i.e., scanline order.

As mentioned above, macro blocks can be grouped into slices, wherein the macro blocks of a given slice can be decoded independent of macro blocks in other slices. Identifying such independent groups is particularly useful in computational systems with parallel processing capability, for example, in processors that have multiple clusters of processing elements that can be independently invoked for processing data.

Dependency lists between macro blocks can be generated in a given situation, for example, by tracing each macro block in scanline order to identify which macro blocks depend on others. Macro blocks that have no dependencies between can be grouped separately, and processed independent of one another. Macro blocks which ultimately depend on one another are grouped together. Developing such a dependency list normally entails visiting each macro block in scanline order, identifying the various dependencies, then grouping to separate independent groups of macro blocks. This process incurs greater computational cost than is necessary, and there exists a need in the art to identify groups of macro blocks (or other nodes in a two-dimensional data set) in a reliable and efficient manner.

Determination of Data Groups Suitable for Parallel Processing

The present innovations include, in one example class of embodiments, a computer implemented system or process that identifies independent data groups (preferably in a two-dimensional data context) that can be independently processed. In preferred embodiments, the present innovations are implemented as an algorithm that identifies a list of root nodes in a set of data nodes, wherein the root nodes are independent of all other data nodes. Using these root nodes, boundaries are traced around groups of data nodes, for example, by following horizontal or vertical dependencies between nodes. By not simply visiting each data node in turn, the present innovations permit identification of independent groups without necessarily needing to visit each and every node of that group. Alternative embodiments are also herein described which can identify groups of independent data when dependency rules are modified, such as when non-horizontal or non-vertical dependencies are introduced.

Other embodiments and aspects of the present innovations are described below.

The disclosed innovations, in various embodiments, provide one or more of at least the following advantages:
improved efficiency for identification of independent groups of data, such as in 2D data sets;
identifies independent groups with lower computational costs;
easy modification of the process to identify independent data groups when dependencies between data nodes change.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows a computer system consistent with implementing a preferred embodiment of the present innovations.

FIG. 2 shows a diagram of a processor context in which the present innovations can be implemented.

FIG. 3 shows an example set of macro blocks (or other 2D data set) with dependencies.

FIG. 4 shows a default processing order for a 2D data set, depicting scanline order.

FIG. 5 shows three groups of macro blocks identified by a process consistent with the present innovations.

FIG. 6 shows three groups of macro blocks identified by a process consistent with the present innovations.

FIG. 7 shows a processing context consistent with implementation of the present innovations.

FIG. 8 shows the grouping of data groups in the context of multiple processing clusters, consistent with an embodiment of the present innovations.

FIG. 9 shows a flowchart with process steps consistent with implementing a preferred embodiment of the present innovations.

FIG. 10 shows a set of data in one dependency context.

FIG. 11 shows a set of data with diagonal dependency.

FIG. 12 shows a modification of dependencies consistent with an embodiment of the present innovations.

FIG. 13 shows a set of data with diagonal dependency.

FIG. 14 shows a modification of dependencies consistent with an embodiment of the present innovations.

### DETAILED DESCRIPTION OF THE PREFERRED EMBODIMENTS

The numerous innovative teachings of the present application will be described with particular reference to the presently preferred embodiment (by way of example, and not of limitation).

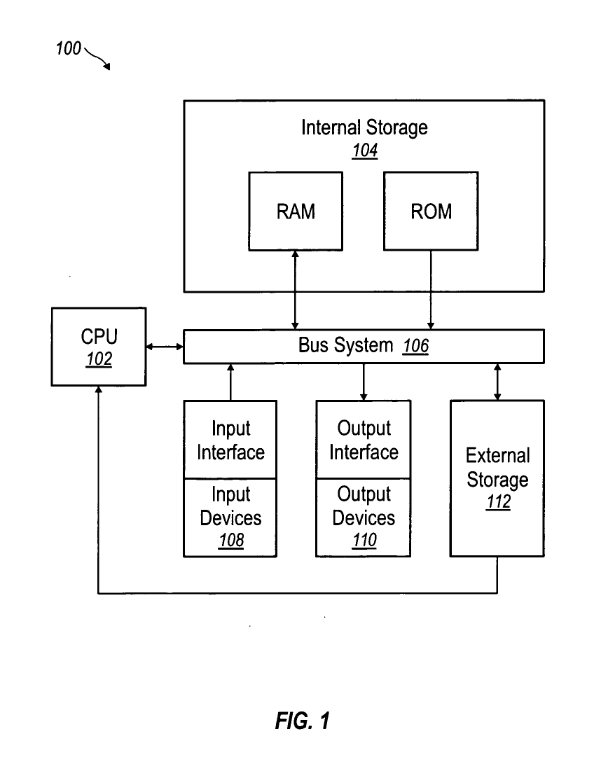

FIG. 1 shows a generalized computer system consistent with implementing a preferred embodiment of the present innovations. In this example, computer system 100 preferably includes a central processing unit (CPU) 102 in communication with a bus system 106. Bus system 106 is herein used as a generic term for the means of communication between the various elements of the computer system, and can include multiple busses of varying types, including but not limited to I2S, I²C, and others. Internal storage 104 includes, for example, random access memory (RAM) and read-only memory (ROM). RAM, for example, is capable of bi-directional communication via bus 106 while ROM is capable of only unidirectional communication via bus 106. Bus 106 also connects input devices 108 (such as keyboard, mouse, joystick, scanner, etc.) via an input interface, output devices 110 (such as a monitor or printer) via an output interface, and external storage devices 112 (such as floppy disc, hard disc, CD ROM, magnetic tape, etc.) to the computer system 100. External storage 112 is shown here as being connected to CPU 102.

It is noted that the particular configuration and examples presented in FIG. 1 are intended only to be illustrative, and are not intended to limit the context or applicability of the present innovations.

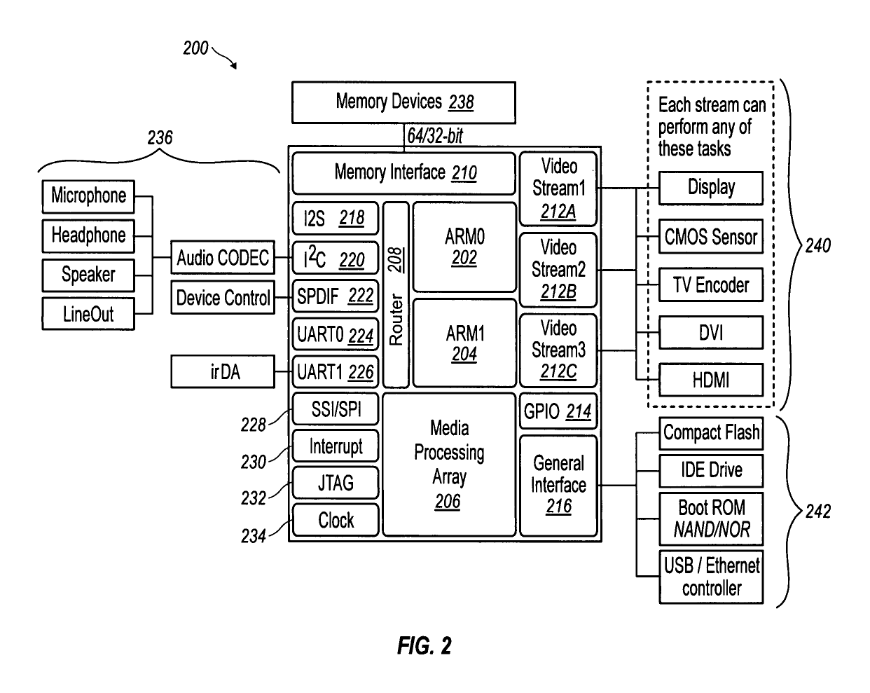

FIG. 2 shows a detail of an example CPU 200, such as CPU 102 of FIG. 1, consistent with a preferred embodiment of the present innovations. In a preferred embodiment, CPU 200 is a media processor designed for video, audio, and graphics, and is implemented as a single integrated circuit microprocessor that operates according to reduced instruction set computer (RISC) techniques. Preferably, it is supported by various software and tools and is capable of operating consistent with various standards, including H264 encode and decode, MP3, OpenGL, and others.

CPU 200 preferably includes a plurality of core processors ARM0 202 and ARM1 204 which communicate with media processing array 206, for example, via an AHB (Advanced High-Performance Bus) interface (not shown) through a router 208. In a preferred embodiment, ARM0 202 is the “control” processor which runs the operating system, while ARM1 204 is an asynchronous co-processor preferably capable of and configured for decoding bit streams such as video bit streams from video stream1 unit 212A, video stream2 unit 212B, and video stream3 unit 212C. In a preferred embodiment, processors 202, 204 are implemented as ARM 926 EJ-S units with the following attributes: 32-bit RISC processor, 16 Kbyte built in RAM, 16 Kbyte instruction cache, 8 Kbyte data cache, 32/16 bit command sets, MMU (memory management unit), 2 interrupt systems, 16 external interrupts, 4 hardware timers and watchdog, and direct execution of Java. CPU 200 also preferably includes a memory interface 210 that communicates with memory devices 238. Video stream units 212A-212C can each preferably perform any of several tasks 240, including display, CMOS sensor, TV encoder, DVI, and HDMI, for example. CPU 200 includes GPIO (general purpose input/output) 214 which provides a set of IO ports which can be configured for either input or output. General interface 216 serves, for example, as external interface for such devices 242 as compact flash memory, IDE drive, Boot ROM, USB/Ethernet controller, etc.

Several interfaces are also shown in this example configuration, some of which are shown interfacing with various systems or devices 236. For example, I2S (Inter IC Sound) 218 is a digital bus interface often used to connect digital audio devices, such as microphones, headphones etc. through an audio CODEC. I²C (Inter-Integrated Circuit) bus 220 is a multi-master bus that can connect multiple chips, allowing each chip to initiate a data transfer. SPDIF 222 (Sony/Phillips Digital Interface) is a digital interface designed to enable digital equipment to handle digital information with minimal loss. UART0 224 and UART1 226 are universal asynchronous receiver/transmitters that act as an interface between devices that handle data in parallel and those which handle data in asynchronous form. SSI/SPI 228 (Synchronous Serial Interface/Serial Parallel Interface) is a general purpose synchronous serial interface. Interrupt unit 230 accepts requests for temporary suspension of a process, performed in such a way that the process can be resumed. JTAG 232 is used for testing connections between chips. Clock 234 is the primary timing circuit for the CPU. It is noted that the particular elements shown in this example are not intended to limit the scope of the present innovations, and are rather intended only as illustrative of one potential implementation.

The present innovations are preferably implemented in the context described above, and provide a system and method for determining data groups which are suitable for parallel processing. For example, in one context, the present innovations describe a system and method for processing intra coded macro blocks in video data, such as a frame of video data, in parallel. In this example, a slice or frame of video data comprises frames or slices that include macro blocks which can be grouped in such a way that the different groups can be processed concurrently. This is accomplished by identifying groups of macro blocks whose processing is dependent only on macro blocks within their respective group.

In one example embodiment, an algorithm identifies a list of root nodes, or nodes which can be processed without reference or dependence on other nodes in a 2D set of data. The algorithm traces a boundary around each independent group. In preferred embodiments, the nodes of the data set are not merely visited in scanline order, nor any other pre-determined order. Instead, the algorithm dynamically follows dependencies until the starting root node is again reached, closing the boundary. This embodiment and others are described more fully below. It is noted that, though the following examples are presented in specific context (such as a particular standard in video coding and decoding), the innovations described here are applicable to any data set with processing dependencies.

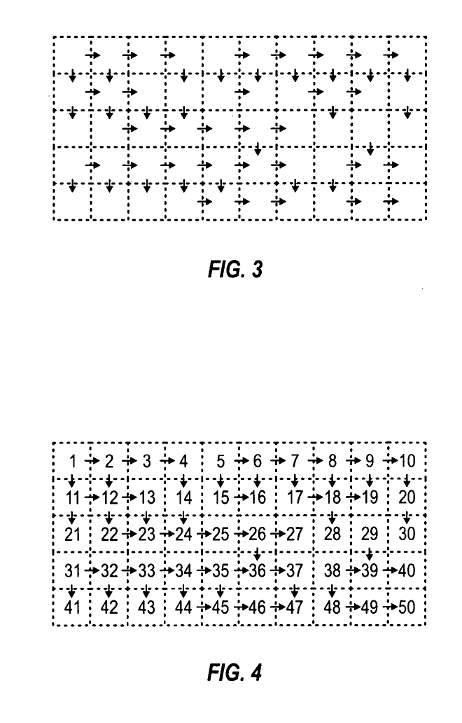

FIG. 3 shows a 2D data set with dependencies between nodes of the data set. Arrows indicate dependent nodes (or macro blocks, depending on the implementation context). In a preferred context, the nodes (represented as blocks in the figures) are macro blocks relating to a 16×16 pixel region in the luma channel of a video frame and an 8×8 region in each of the chroma channels of the frame. The use of the video context is not intended to limit applicability of the scope of the present innovations, and is only used here as an illustrative case.

The data set depicted in FIG. 3 is smaller than a typical frame in video, and is used here for illustrative purposes only. The arrows between nodes represent processing dependencies. For example, in a video context, such as the H.264 standard, intra coded macro blocks are processed by forming a prediction for the luma and chroma channels from neighboring macro blocks that have already been reconstructed. This prediction is then optionally combined with residual data from the bit stream to form the final reconstructed channel data. The reconstructed data can then be used to form a prediction for the macro blocks below and to the right that are decoded at a later time. Macro blocks within a slice are decoded in scan line order—left to right, top to bottom. A particular macro block can be dependent on up to three macro blocks which, due to the decode order in this example, must be to the left of the current macro block in the same scan line or in the scan line of macro blocks above the current macro block. The exact dependencies of a particular macro block are governed by the encoder and will vary from one encoder to another, and for a single encoder with different parameters. Therefore, a generic dependency list does not exist. The only safe order to process Intra coded macro blocks using the information in the bit stream is the decode order, i.e., scan line order.

The present innovations provide a system and method that identifies a group or groups of macro blocks (for example, in a slice or a frame of video, or in other data processing contexts) that can be processed concurrently. The macro blocks within a group are preferably processed in order but the groups themselves can be processed in any order, and in total isolation from any other group without breaking data dependencies. In other words, once independent groups are identified, they may be processed in any order, and each may be processed without reference to macro blocks in other groups.

Using the information in the bit stream, only one macro block can be processed at a time. The processing order, for the example given in FIG. 3, would be as depicted in FIG. 4.

However, using the present innovations, several different groups of macro blocks (for example, in a slice or frame of video) can be decoded concurrently. A list of root nodes, or macro blocks that have no dependencies, is created during decode. This is a low cost operation. The algorithm of the present innovations traces group boundaries by following horizontal and vertical dependencies, starting at a root node. Root nodes are preferably processed in this way in scan line order, though they need not be in some implementations.

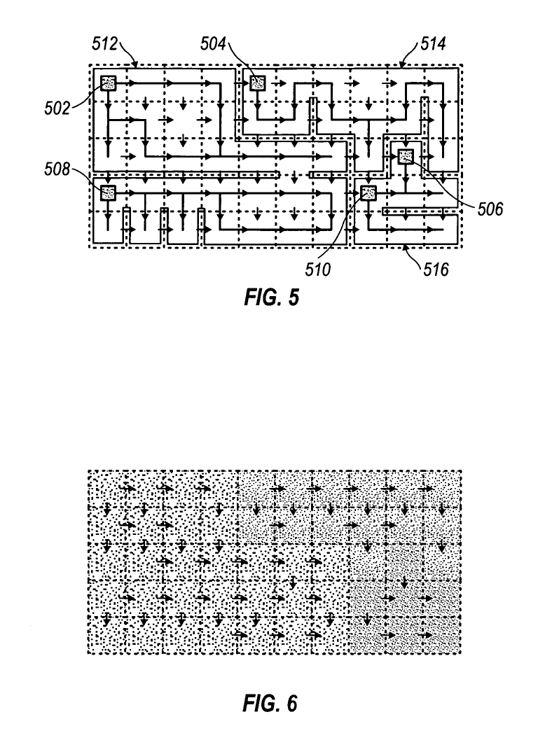

FIG. 5 shows three groups of macro blocks that have been identified as independent of one another. In other words, the macro blocks of any one group depends only on macro blocks within that group (if any). Because the different groups do not have interdependence, they can be processed concurrently. Concurrent processing is particularly useful in some processing contexts, such as when a plurality of processing elements can be applied simultaneously to different data, such as in a SIMD (single instruction, multiple data) processing context or other vector processing contexts.

In the example of FIG. 5, five root nodes 502-510 have been identified, preferably in scan line order by testing each node to see if it is dependent on any other nodes. If a node is not dependent on any other nodes, it is identified as a root node and can serve as the starting point for identifying independent groups of nodes. The groups 512, 514, 516 themselves are outlined to include all nodes of each group. Dependencies are depicted with arrows. The path of the algorithm that traces the boundary of each group overlays the dependency arrows. It is noted that the algorithm preferably does not visit each node in the group, but instead only traces the perimeter of the group. This can be accomplished with an algorithm that, starting at a root node, tests nodes in, for example, a “clockwise” or “counterclockwise” fashion, following dependencies (and turning when no dependency is found), until it returns to the root node whence it began.

The boundaries of a given group are thus, preferably, identified by tracing the perimeter of each group rather than visiting each macro block in turn. Because (in preferred embodiments) only the macro blocks along the boundary are visited, the computational cost is kept to a minimum for large groups of macro blocks. In some applications, the final stage that marks the blocks within a group does visit each macro block but is not as complex as the initial boundary identification.

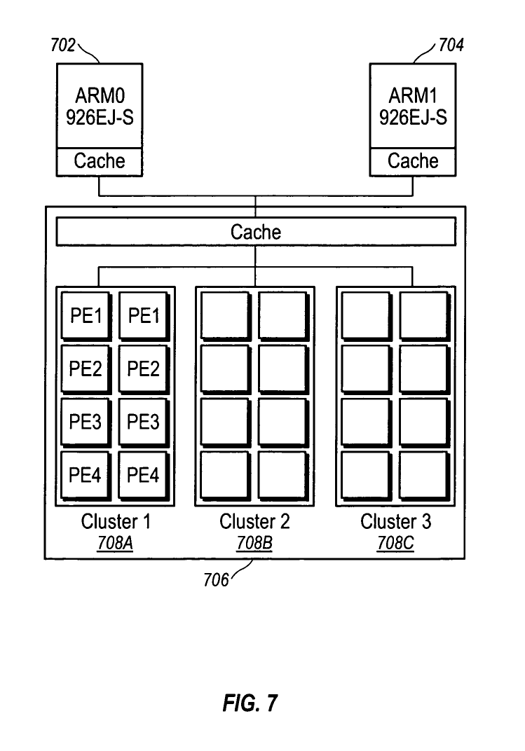

FIG. 6 shows the same situation as depicted in FIG. 5. The groups in FIG. 6 are shown by the three shaded regions. Any macro block in a given group is dependent on only macro blocks in that group (or, in the case of root nodes, is not dependent on any other macro block). The three groups represented in FIG. 6 can be processed independently of one another, and therefore can be processed concurrently. This is particularly useful in a processor environment where multiple processing element clusters are available for use, as shown in FIG. 7, below.

FIG. 7 shows an example implementation context, namely, an example media processing array. In this example, two processor cores 702, 704 (in this example, ARM or 32 bit RISC processor cores are shown) are attached to a media processing array 706. The media processing array 706 of this example includes three clusters of processing elements 708A, 708B, 708C. Each of clusters 708 includes, in this example, 8 processing elements (e.g., PE1, PE2 . . . ). Multiple caches are also shown. This example configuration is one possible context (out of many) in which the present innovations can be implemented. For example, in a media application, where the different groups (for example, groups 512, 514, 516 of FIG. 5) represent groups of macro blocks which can be independently processed (as identified by the innovations presented herein), the clusters 708 can be independently used to process a separate group concurrently. Concurrent processing of independent groups provides a faster decode of, for example, video data, resulting in better performance.

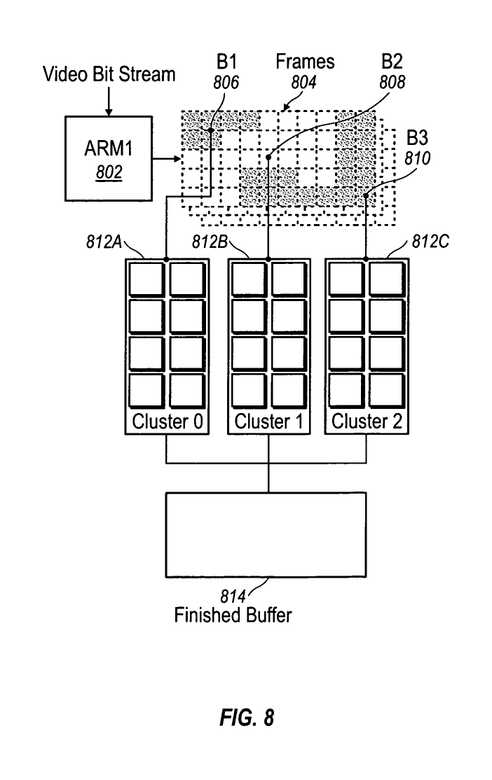

The application of separate clusters of processing elements to independent groups is depicted in FIG. 8. In this example, processor 802 manages decode of a video bit stream which comprises frame(s) 804 of video data. In this example, the frames comprise a two-dimensional set of macro blocks, though other data could also be used. In this example, the frame 804 has been subdivided by an embodiment of the present innovations into three groups 806, 808, 810 of data, the three groups being independent of one another as described above. In one class of preferred embodiments, each group is sent to a different processing element cluster 812 for independent processing. For example, group 806 is processed by cluster 812A, group 808 is processed by cluster 812B, and group 810 is processed by cluster 812C. The results of processing are input to buffer 814, in this example, shown as a frame of video.

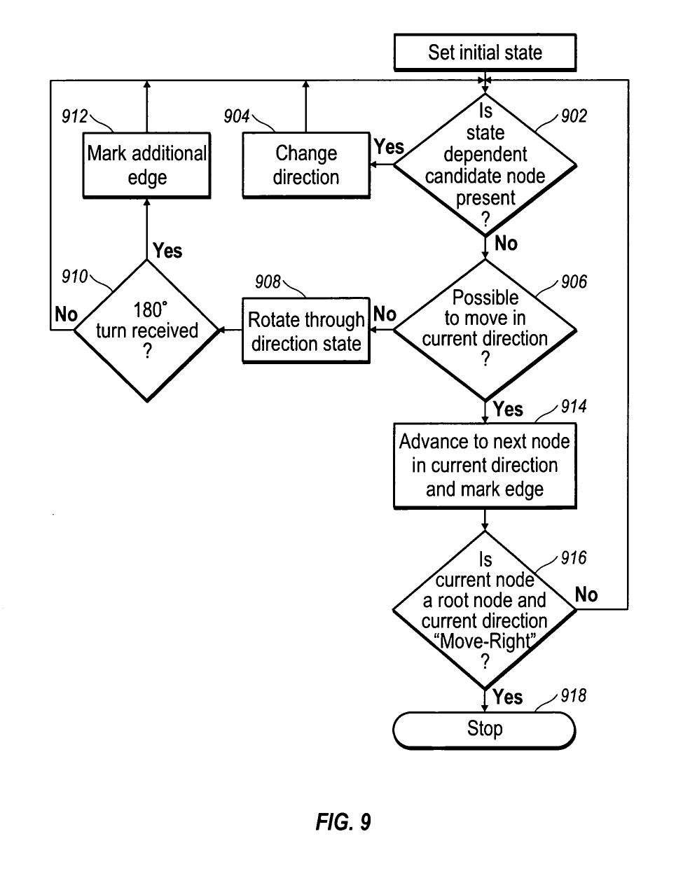

FIG. 9 shows a flowchart for implementing process steps consistent with an embodiment of the present innovations. This flowchart demonstrates only one possible example, and many other ways of implementing the present innovations can be used.

The process begins with the initial state set (step 900). The initial state is described more fully below. For example, “MOVE_RIGHT” is a preferred initial state, though any initial state can be used. The process next determines whether a state dependent candidate node is present (step 902). If so, then the direction is changed (step 904) and the process returns as shown in FIG. 9. If no state dependent candidate node is present, then the process determines whether it is possible to move in the current direction (step 906). If not, then the direction is rotated (see below for further details) (step 908) and then determines whether a 180 degree turn is required (step 910). If not, the process returns. If so, an additional edge is marked (step 912) and the process then returns. If it is possible to move in the current direction, then the process advances to the next node in that current direction and marks an edge (step 914). Next, the process determines whether the current node is a root node and whether the current direction is “MOVE_RIGHT” (step 916). If not, the process returns. If so, the an additional edge is marked (step 918) and the process returns.

In this example embodiment, when tracing an edge the system is preferably characterized as being in one of four directional states (MOVE_LEFT, MOVE_DOWN, MOVE_RIGHT or MOVE_UP), and the initial state is set to MOVE_LEFT for each root node. An edge is traced by moving from one node to the next in a given direction, following decoding dependencies, until a state dependant candidate node (see table 1, below) is located or it is not possible to continue in the current direction because either the edge of a constrained region has been reached (i.e frame boundary) or there is no dependency between the current node and the neighboring node in the direction of travel.

An example of a plain language algorithm for tracing an edge is depicted below, consistent with one example embodiment of the present innovations.

Set initial state to MOVE_RIGHT
loop:

if state dependant candidate node present

change direction
jump to loop

if not possible to move in current direction

rotate through direction state
jump to loop

advance to next node in current direction
if current node == root node and current state ==

MOVE_RIGHT

stop

jump to loop

In preferred embodiments, a basic premise of the edge tracing algorithm is to encompass as many nodes as possible. This is preferably achieved by the following to behaviors:
1) The directional state will change to favor candidate nodes when present

2) The directional state rotates clockwise (MOVE_RIGHT>MOVE_DOWN>MOVE_LEFT>MOVE_UP) when it is not possible to continue in the current direction (table 2)

TABLE 1
Location of candidate node for given state
when checking for additional work

| State | Location of candidate |
|---|---|
| MOVE_RIGHT | Above |
| MOVE_DOWN | Right |
| MOVE_LEFT | Below |
| MOVE_UP | Left |

TABLE 2
State transition when it is not possible
to continue in current directional state

| State | Next state |
|---|---|
| MOVE_RIGHT | MOVE_DOWN |
| MOVE_DOWN | MOVE_LEFT |
| MOVE_LEFT | MOVE_UP |
| MOVE_UP | MOVE_DOWN |

When moving from one node to the next an appropriate edge is preferably marked (see table 3). In less preferred embodiments, edges can be collected and marked at a later time. It is the edge information that is used in a second part of the algorithm (called closing) to form the groups.

TABLE 3
Marked edges for each state

| State | Marked edge |
|---|---|
| MOVE_RIGHT | EDGE_TOP |
| MOVE_DOWN | EDGE_RIGHT |
| MOVE_LEFT | EDGE_BOTTOM |
| MOVE_UP | EDGE_LEFT |

Because edges are preferably marked on leaving a node it is sometimes necessary for additional edges to be marked when transitioning from one direction state to another to ensue that the edge is properly closed, see table 4. In order to close the traced edge for features that are only one node across or high, which happens when the direction flips 180 degrees in a single node, the additional marking shown in table 5 of the first node for the current edge is preferably used. Note that not all additional edges must be marked for the algorithm to function but they are all listed here for completeness.

TABLE 4
Additional edge marking

| Marked edge | New direction | Additional edge |
|---|---|---|
| EDGE_TOP | MOVE_DOWN | EDGE_TOP |
| EDGE_RIGHT | MOVE_LEFT | EDGE_RIGHT |
| EDGE_BOTTOM | MOVE_UP | EDGE_BOTTOM |
| EDGE_LEFT | MOVE_RIGHT | EDGE_LEFT |

TABLE 5
Marking of edges when direction is reversed in a single node

| Previously marked edge | Current edge | Additional edge |
|---|---|---|
| EDGE_RIGHT | EDGE_LEFT | EDGE_BOTTOM |
| EDGE_LEFT | EDGE_RIGHT | EDGE_TOP |
| EDGE_BOTTOM | EDGE_TOP | EDGE_LEFT |
| EDGE_TOP | EDGE_BOTTOM | EDGE_RIGHT |

It is also preferable to clear the edge flag for the first node of an edge under certain conditions (for example, those listed in table 6) so that internal corners are not blocked. Note that not all combinations must be cleared for the algorithm to function but they are all listed here for completeness.

TABLE 6
Edge combinations that require clearing
of edge flag in first node of edge

| Previously marked edge | Current Edge |
|---|---|
| EDGE_LEFT | EDGE_BOTTOM |
| EDGE_BOTTOM | EDGE_RIGHT |
| EDGE_RIGHT | EDGE_TOP |
| EDGE_TOP | EDGE_LEFT |

The examples of FIGS. 5 and 6 show dependencies that are immediately to the left and above a given node. Other types of dependencies, namely diagonal on nodes above left or above right with respect to a given node, are not considered. For example, the H.264 standard allows for other dependencies, such as above left and above right. Such cases can be handled in alternative embodiments by modifying the connectivity of the dependencies, for example, changing a diagonal connection to a horizontal or vertical connection, and by ensuring macro blocks are processed in scan line order within a group. This alternative embodiment, true under some standards but not all, could cause macro blocks to be included in a group that need not be, and hence merge groups together. However, it would prevent diagonal dependent blocks from being excluded from groups with blocks on which they are dependent.

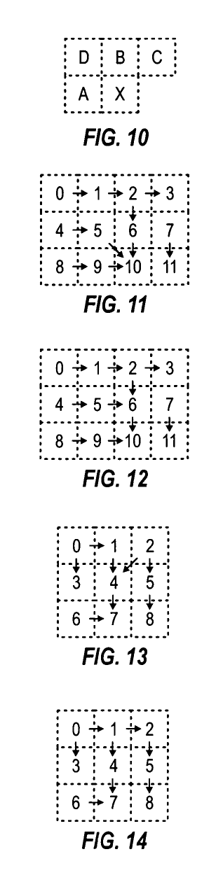

The following figures provide an alternative embodiment for dealing with the potential of diagonal dependencies in two-dimensional data sets. FIG. 10 shows an example set of 2D data (macro blocks are used in this example) that include a macro block x and macro blocks A-D, which x can be dependent on, representing dependencies above (B), to the left (A), and diagonally up toward both the left (D) and the right (C).

In an example embodiment, the connectivity of one or more macro block is adjusted. In this example, Consider FIG. 11, which has macro block 10 which is predicted from 5, 6, and 9. With only horizontal and vertical boundary tracing, macro block 5 will not be found from macro block 10 whilst tracing the group boundaries. Additionally, without modification of the connectivity of macro block 9 or 6, macro blocks 4 and 5 will be in a separate group from 6 and 9 so there is no guarantee that it will be processed prior to processing macro block 10.

To ensure that macro block 5 is processed prior to 10, the connectivity of 6 can be modified (for the purposes of boundary tracking only, in preferred embodiments) so that macro block 5 is included in the same group. This is shown in FIG. 12. For purposes of the boundary tracking, the dependency of 10 on 5 is adjusted so that 10 no longer depends on 5, but instead 6 is dependent on 5. 10 is also dependent on 6, so the net result provides for proper ordering and processing of the blocks, while avoiding the need to trace diagonal dependencies in boundary tracing.

Similarly, it is preferable to adjust the connectivity of neighbor C (as shown in FIG. 10) when macro block C is used in a prediction. FIG. 13 shows such a situation, with macro block 4 depending on macro block 2. Here, macro block 2 is set dependent on macro block 1. It is necessary for macro block 4 to be dependent on 1 also but this is always the case when 4 is dependent on 2 because of restrictions in the H.264 standard. The dependencies in FIG. 14 show how those of FIG. 13 can be modified to properly group the macro blocks, while avoiding the need to track diagonal connectivity when tracing boundaries. In FIG. 14, the dependency of 4 on 2 has been (for boundary tracing purposes) eliminated and replaced with a dependency of 2 on 1. Note that with straight horizontal and vertical dependencies, 4 does not appear to depend on 2, but the net results includes 2 in the group with 4. So if, for example, the blocks in the group are processed in scanline order, 2 will be processed before 4 anyway, and the actual connectivity between 2 and 4 will still be honored, and 4 can be properly processed. The connectivity change merely ensures that macro block 2 is in the same group as 4, and we rely on the closing process, which (in this example) processes the blocks in scanline order.

According to a disclosed class of innovative embodiments, there is provided: A method of identifying data groups suitable for parallel processing, comprising the steps of: tracing boundaries around groups of nodes in a set of nodes, wherein processing of nodes within a given group does not depend on nodes not within that group.

According to a disclosed class of innovative embodiments, there is provided: A method of identifying groups, in a 2D set of nodes, suitable for parallel processing, comprising the steps of: identifying a plurality of root nodes in the set, wherein processing of at least some nodes of the set depends on other nodes of the set, and wherein processing of the root nodes does not depend on other nodes of the set; starting at a first root node, following dependencies between nodes until the first root node is reached.

According to a disclosed class of innovative embodiments, there is provided: A method for decoding video data, comprising the steps of: identifying, in a set of nodes, a plurality of root nodes whose decoding does not depend on other nodes of the set; starting at a first root node of the plurality of root nodes, following decoding dependencies between nodes until the first root node is again reached to thereby identify a first group of nodes; starting at a second root node of the plurality of root nodes, following decoding dependencies between nodes until the second root node is again reached to thereby identify a second group of nodes; decoding the first and second groups of nodes concurrently.

Modifications and Variations

As will be recognized by those skilled in the art, the innovative concepts described in the present application can be modified and varied over a tremendous range of applications, and accordingly the scope of patented subject matter is not limited by any of the specific exemplary teachings given.

For example, the application of the present innovations is not limited to intra prediction, and could be applied to large 2D data sets with similar ordering dependencies.

For another example, the present innovations can be used for identifying independent groups of macro blocks for H.264 (or any other standard) edge filtering.

Additional general background, which helps to show variations and implementations, may be found in the following publications, all of which are hereby incorporated by reference: “H.264 and MPEG-4 Video Compression: Video Coding for Next Generation Multimedia,” by Richardson, John Wiley & Sons (Aug. 12, 2003).

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A method of identifying data groups suitable for parallel processing, 5 comprising the steps of:
tracing boundaries around groups of nodes in a set of nodes, wherein processing of nodes within a given group does not depend on nodes not within that group.

2. The method of claim 1, wherein a boundary is traced by following dependencies between nodes, starting at a root node whose processing does not depend on any other node of the set.

3. (canceled)

4. The method of claim 1, wherein not all nodes of the set are visited during the tracing of the boundaries.

5. The method of claim 1, wherein the groups are processed in parallel.

6. The method of claim 1, wherein each group includes at least one root node whose processing does not depend on other nodes of the set.

7. The method of claim 6, wherein at least some of the root nodes are processed in scanline order when checking for potential starting points of a group.

8. (canceled)

9. (canceled)

10. The method of claim 1, wherein the nodes are macro blocks relating to a pixel region, and the set of nodes is a frame of video data.

11. The method of claim 1, wherein the nodes of a given group are processed in scanline order.

12. The method of claim 1, wherein nodes are arranged in a 2D data set, and wherein the dependencies between nodes are horizontal and vertical dependencies. 15

13. A method of identifying groups, in a 2D set of nodes, suitable for parallel processing, comprising the steps of:
identifying a plurality of root nodes in the set, wherein processing of at least some nodes of the set depends on other nodes of the set, and wherein processing of 20 the root nodes does not depend on other nodes of the set;
starting at a first root node, following dependencies between nodes until the first root node is reached.

14. The method of claim 13, wherein the dependencies are vertical and 25 horizontal dependencies.

15. The method of claim 13, wherein not all nodes of the set are visited during the tracing of the boundaries.

16. The method of claim 13, wherein the groups are processed in parallel.

17. The method of claim 2, further comprising the steps of: after the first root node is reached, starting at a second root node, following dependencies between nodes until the second root node is reached.

18. The method of claim 13, wherein the first root node and the second root node are processed in scanline order.

19. (canceled)

20. The method of claim 13, wherein the nodes are macro blocks relating to a pixel region, and the set of nodes is a frame of video.

21. The method of claim 13, wherein the step of following dependencies is used 20 to identify a group of nodes whose processing does not depend on nodes outside the group, and wherein the nodes of a group are processed in scanline order.

22. A method for decoding video data, comprising the steps of:
identifying, in a set of nodes, a plurality of root nodes whose decoding does not depend on other nodes of the set;
starting at a first root node of the plurality of root nodes, following decoding 5 dependencies between nodes until the first root node is again reached to thereby identify a first group of nodes;
starting at a second root node of the plurality of root nodes, following decoding dependencies between nodes until the second root node is again reached to thereby identify a second group of nodes;
decoding the first and second groups of nodes concurrently.

23. The method of claim 22, wherein the nodes are arranged in a 2D array, and wherein the plurality of root nodes are identified in scanline order.

24. (canceled)

25. The method of claim 22, wherein not all nodes of a group are visited during the process of identifying that group.

26. The method of claim 22, wherein the nodes are macro blocks of a video frame.
